(19) United States
(12) Patent Application Publication
(10) Pub. No.: US 2010/0270991 A1
(43) Pub. Date: Oct. 28, 2010

(54) DC-DC CONVERTER

(75) Inventor: Takamune Suzuki, Saitama-ken (JP)

Correspondence Address: WILMERHALE/DC, 1875 PENNSYLVANIA AVE., NW, WASHINGTON, DC, 20006, US

(73) Assignee: SANKEN ELECTRIC CO., LTD., Saitama-ken (JP)

(21) Appl. No.: 12/766,262

(22) Filed: Apr. 23, 2010

(30) Foreign Application Priority Data
Apr. 23, 2009 (JP) 2009-105462

(51) Int. Cl. G05F 1/10

(52) U.S. Cl. 323/282

(57) ABSTRACT

A switching regulator for stepping down a DC input voltage to a DC output voltage, the switching regulator including: a switching element; a control circuit that controls activation or deactivation of the switching element; a voltage generation unit that steps down the DC input voltage and supplies the stepped down DC input voltage to the control circuit; and a switching unit that is configured to: supply the DC output voltage to the control unit when the DC output voltage is equal to or higher than a first reference voltage; and stop supply of the DC output voltage when the switching element is in an active state.

This application claims priority from Japanese Patent Application No. 2009-105462 filed on Apr. 23, 2009, the entire subject matter of which is incorporated herein by reference.

### BACKGROUND OF THE INVENTION

1. Field of the Invention

The present invention relates to a DC-DC converter and, more specifically, to a step-down switching regulator.

2. Description of the Related Art

FIG. 9 is a circuit diagram showing a configuration of a related-art step-down switching regulator (see, for example, JP-A-2001-25239).

The related-art step-down switching regulator includes: a DC input voltage Vin′; a switching element Q100 including a MOSFET whose drain terminal is connected to the DC input voltage Vin′; a reflux diode D100 connected to a point between a source terminal of the switching element Q100 and a ground; a series circuit including an inductor L100 connected in parallel to the reflux diode D100 and an output capacitor Co′; a load R100 connected to a point between the ground and a point of connection between the inductor L100 and the output capacitor Co′; a control circuit 100 that controls activation and deactivation of the switching element Q100; and a voltage generation unit 200 and a reflux prevention diode D200 connected to a point between the DC input voltage Vin′ and the control circuit 100. Moreover, the related-art step-down switching regulator includes: a switching unit S100 connected to a point between the output capacitor Co′ and the control circuit 100; and a signal generation unit 300 that opens and closes the switching unit 5100 according to a DC output voltage Vo′ (equal to a voltage of the output capacitor Co′).

The control circuit 100 includes: a driver 120 that amplifies a pulse signal VG′, which is input from an outside to activate the switching Q100, so as to output a gate drive signal; and a capacitor 110 for biasing the driver 120. When the DC output voltage Vo′ has become greater than a predetermined voltage value Vref, the signal generation unit 300 generates and outputs a control signal V300 so as to close (turn ON) the switching unit 5100 and deactivates the voltage generation unit 200.

In accordance with the gate drive signal input to a gate terminal of the switching element Q100 from the control circuit 100, the related-art step-down switching regulator controls activation and deactivation of the switching element Q100 and converts the DC input voltage Vin′ into a lower DC output voltage Vo′ by way of an LC filter including the inductor L100 and the output capacitor Co′, and supplies the DC output voltage Vo′ to the load R100.

Further, when the DC output voltage Vo′ is comparatively small, such as that produced immediately after startup of the switching regulator, the related-art step-down switching regulator recharges the capacitor 110 with the DC input voltage Vin′ by way of the voltage generation unit 200 including a linear regulator. When the DC output voltage Vo′ is comparatively high, the capacitor 110 is recharged with the DC output voltage Vo′. Through such an operation, the related-art step-down switching regulator lessens a loss arising in the voltage generation unit 200, whereby the step-down switching regulator exhibiting high conversion efficiency is implemented.

However, the related-art step-down switching regulator has a problem with reliability as will be described below.

Provided that a voltage appearing at the point of connection between the switching unit 5100 and the control circuit 100 with reference to the GND is V110, the DC input voltage Vin′ is superimposed on a charging voltage of the capacitor 110 along with activation and deactivation of the switching element Q100, so that the voltage V110 becomes higher at the time of activation of the switching element Q100 (FIG. 10). For instance, as a result of the switching unit S100 entering electrical conduction at time t1′, the capacitor 110 starts being recharged with the DC output voltage Vo′, and the voltage V110 subsequently becomes substantially equal to the DC output voltage Vo′ when the pulse signal VG′ is at an L level. Moreover, when the pulse signal VG′ is at an H level, the voltage V110 becomes substantially equal to the voltage produced as a result of the DC input voltage Vin′ being superimposed on the DC output voltage Vo′. When the voltage V110 becomes higher than the DC output voltage Vo′ as described above, the voltage V110 is applied to the load R100 and the signal generation unit 300, which in turn arouses a concern about destruction of the load R100 and the signal generation unit 300, which would otherwise be caused by an excess voltage. Thus, the related-art step-down switching regulator has the problem with reliability.

Such destruction of the load R100 and the signal generation unit 300 can be prevented by additionally interposing a reflux prevention diode between the load R100, the signal generation unit 300 and the capacitor 110. However, when the capacitor 110 is recharged with the DC output voltage Vo′, a loss attributable to a Vf (a forward voltage) of the diode arises. Further, a voltage level of the gate drive signal is decreased by a voltage drop of the diode, so that a conduction loss of the switching element Q100 arises. Consequently, the loss hinders enhancement of efficiency.

### SUMMARY OF THE INVENTION

The present invention provides a step-down switching regulator exhibiting superior conversion efficiency and reliability.

According to one aspect of the invention, there is provided a switching regulator for stepping down a DC input voltage to a DC output voltage, the switching regulator comprising: a switching element; a control circuit that controls activation or deactivation of the switching element; a voltage generation unit that steps down the DC input voltage and supplies the stepped down DC input voltage to the control circuit; and a switching unit that is configured to: supply the DC output voltage to the control unit when the DC output voltage is equal to or higher than a first reference voltage; and stop supply of the DC output voltage when the switching element is in an active state.

According to another aspect of the invention, there is provided a controlling method of a switching regulator for stepping down a DC input voltage to a DC output voltage by activating and deactivating a switching element, the switching regulator comprising: the switching element; a control circuit for controlling activation or deactivation of the switching element; a voltage generation unit that steps down the DC input voltage and supplies the stepped down DC input voltage to the control circuit, the controlling method comprising: supplying the DC output voltage to the control circuit when the DC output voltage is equal to or greater than the first reference voltage value; and stopping supply of the DC output voltage when the switching element is in an activated state.

According to the aspects of the invention, it is possible to provide a step-down switching regulator exhibiting superior conversion efficiency and reliability.

### BRIEF DESCRIPTION OF THE DRAWINGS

FIG. 1 is a circuit diagram showing a configuration of a step-down switching regulator according to a first embodiment of the present invention;

FIG. 2 is a circuit diagram showing a configuration of a principal section of the step-down switching regulator according to the first embodiment of the present invention;

FIG. 3 is a circuit diagram showing a detailed configuration of a switching unit according to the first embodiment of the present invention;

FIG. 4 is a waveform chart showing operations of respective sections of the step-down switching regulator according to the first embodiment of the present invention;

FIG. 5 is a circuit diagram showing a configuration of a principal section of a step-down switching regulator according to a second embodiment of the present invention;

FIG. 6 is a circuit diagram showing a detailed configuration of a switching unit according to the second embodiment of the present invention;

FIG. 7 is a waveform chart showing operations of respective sections of the step-down switching regulator according to the second embodiment of the present invention;

FIG. 8 is a circuit diagram showing a detailed configuration of a switching unit according to a modification of the second embodiment of the present invention;

FIG. 9 is a circuit diagram showing a configuration of a related-art step-down switching regulator; and

FIG. 10 is a waveform chart showing operations of respective sections of the related-art step-down switching regulator.

### DETAILED DESCRIPTION OF THE PREFERRED EMBODIMENTS

Embodiments of the present invention are now described by reference to the drawings. In a description of the drawings, identical or like elements are assigned identical or like symbols or reference numerals.

### First Embodiment

A step-down switching regulator according to an embodiment of the present invention includes: a switching element Q1; a DC input voltage Vin; a DC output voltage Vo; a control circuit 1; a voltage generation unit 2; and a switching unit S1.

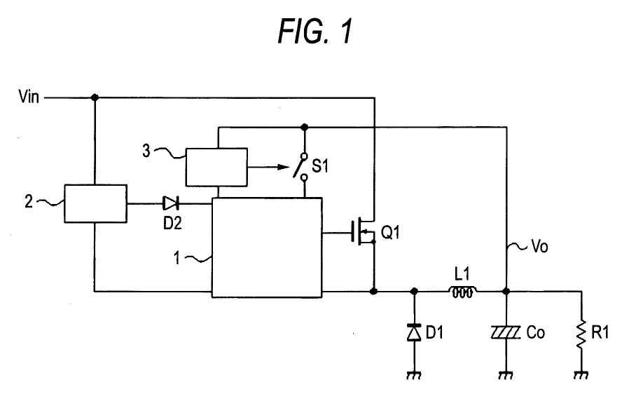

A configuration of the step-down switching regulator according to a first embodiment of the present invention will be described with reference to FIG. 1.

The step-down switching regulator of the embodiment shown in FIG. 1 includes the DC input voltage Vin; the switching element Q1 built from an n-type MOSFET whose drain terminal is connected to the DC input voltage Vin; a reflux diode D1 connected to a point between a source terminal of the switching element Q1 and a ground; a series circuit including an inductor L1 connected in parallel to the reflux diode D1 and an output capacitor Co; a load R1 connected to a point between the ground and a point of connection between the inductor L1 and the output capacitor Co; the control circuit 1 that controls activation and deactivation of the switching element Q1; and the voltage generation unit 2 and a reflux prevention diode D2 connected to points between the DC input voltage Vin and the control circuit 1. The step-down switching regulator of the present embodiment additionally includes the switching unit S1 connected to a point between the output capacitor Co and the control circuit 1 and a signal generation unit 3 that controls the switching unit in synchronism with the DC output voltage Vo (equal to a voltage of the output capacitor Co) and activation and deactivation of the switching element Q1.

The DC input voltage Vin includes, for instance, a rectifier circuit and a smoother circuit. The DC input voltage outputs a DC voltage originating from power supplied from the outside of the step-down switching regulator to a drain terminal of the switching element Q1 and one end of the voltage generation unit 2.

In accordance with a gate drive signal input to a gate terminal from the control circuit 1, the switching element Q1 intermittently outputs the DC input voltage Vin from the source terminal to the inductor L1.

An anode of the reflux diode D1 is connected to the ground, and a cathode of the same is connected to a point of connection between the source terminal of the switching element Q1 and one end of the inductor L1. In the step-down switching regulator, when the switching element Q1 is turned on, an electric current flow along a path consisting of the Vin, the Q1, the L1, the Co, and the GND.

When the switching element Q1 is turned off, the electric current flows along a path consisting of the D1, the L1, the Co, and the GND. According thereto, the step-down switching regulator drops the DC input voltage Vin.

The other end of the inductor L1 is connected to the output capacitor Co and the load R1. The inductor L1 and the output capacitor Co make up a smoother circuit. The output capacitor Co outputs to the load R1 the DC output voltage Vo produced by lowering and smoothing the DC input voltage Vin.

The control circuit 1 outputs a gate drive signal for controlling performance/nonperformance of switching operation is output to a gate terminal of the switching element Q1. The gate drive signal includes alternate repetition of an H level and an L level. The switching element Q1 is controlled by changing a duty ratio of the H level to the L level in one period, thereby making the DC output voltage Vo close to a desired value.

The voltage generation unit 2 includes, for instance, a linear regulator. The DC input voltage Vin is caused to step down by the voltage generation unit 2 and is supplied, by way of the reflux prevention diode D2, to the control circuit 1 as control power for driving the control circuit 1 and also as bias power for activating the switching element Q1. In other words, the voltage generation unit 2 steps down the DC input voltage Vin to generate the control power for driving the control circuit 1 and the bias power for activating the switching element Q1 and supplies the control power and the bias power to the control circuit 1 via the reflux prevention diode D2.

An anode of the reflux prevention diode D2 is connected to the other end of the voltage generation unit 2, and a cathode of the same is connected to the control circuit 1.

A control terminal of the switching unit S1 is connected to the signal generation unit 3 so as to open and close a connection between the output capacitor Co and the control circuit 1. When the switching unit S1 is closed (turned ON), an electrical connection is established between the output capacitor Co and the control circuit 1. The control circuit 1 is supplied with the DC output voltage Vo as the control power for driving the control circuit 1 and the bias power for operating the switching element Q1. Meanwhile, when the switching unit S1 is open (turned OFF), the output capacitor Co and the control circuit 1 are insulated from each other, so that supply of the control power and the bias power is stopped.

The signal generation unit 3 is connected to the output capacitor Co, the control circuit 1, and the switching unit S1 and outputs a control signal for opening and closing (turning ON and OFF) the switching unit S1. The signal generation unit 3 opens and closes (turns ON and OFF) the switching unit S1 according to the voltage of the DC output voltage Vo. In addition, the signal generation unit 3 opens and closes (turns ON and OFF) the switching unit S1 in synchronism with activating and deactivating operations of the switching element Q1.

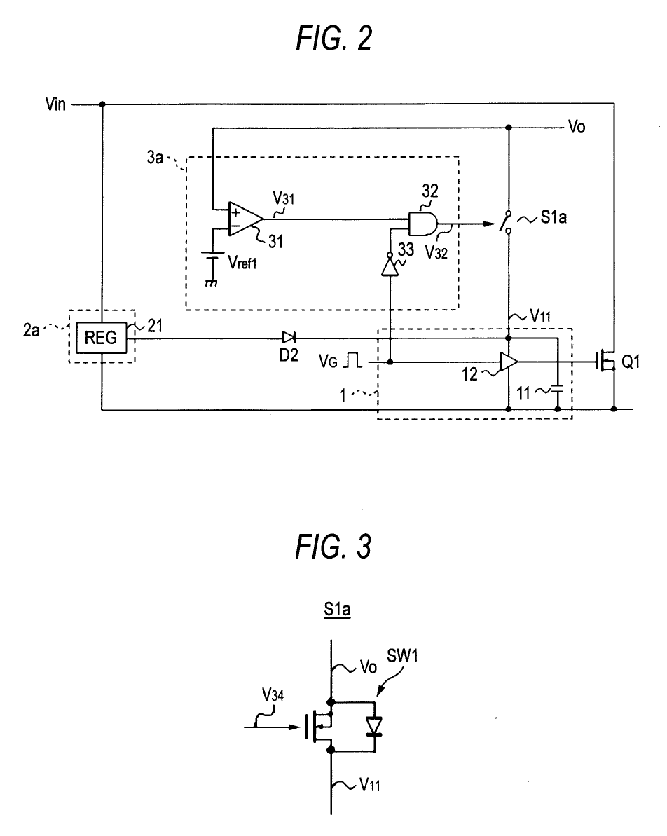

A detailed configuration and operation of the step-down switching regulator of the embodiment will now be described with reference to FIGS. 2 to 4.

FIG. 2 shows the principal section of the step-down switching regulator of the present invention shown in FIG. 1.

In the step-down switching regulator of the present embodiment, the control circuit 1 includes: a driver 12 that amplifies a pulse signal VG input from the outside in order to output a gate drive signal to the switching element Q1; and a capacitor 11 for biasing the driver 12.

A voltage generation unit 2a includes a linear regulator 21. The linear regulator 21 lowers the DC input voltage Vin, supplies the lowered input voltage Vin, as the control power for the control circuit 1 and the bias power for the driver 12, to the control circuit by way of the reflux prevention diode D2 so as to recharge the capacitor 11.

A signal generation unit 3a includes: a first comparator 31; an AND circuit 32; and a NOT circuit 33. The DC output voltage Vo is input to a noninverting input terminal of the first comparator 31, and a first reference voltage Vref1 is input to an inverting input terminal of the same. According to a result of comparison, the first comparator 31 outputs an H-level or L-level comparison signal V31 from the output terminal. When the DC output voltage Vo is higher than the first reference voltage Vref1, the first comparator 31 outputs an H-level comparison signal to one of input terminals of the AND circuit 32. The first reference voltage Vref1 is set in response to the voltage value required by the control circuit 1.

An output from the NOT circuit 33 is input to the other input terminal of the AND circuit 32, and the AND circuit 32 outputs from its output terminal an H-level or L-level signal V32 in response to a computation result. Only when the output from the first comparator 31 and the output from the NOT circuit 33 are at an H level, the AND circuit 32 outputs an H-level signal to a control terminal of a switching means S1a, thereby closing (turning ON) the switching unit S1a.

The pulse signal VG input from the outside to the control circuit 1 is input to the input terminal of the NOT circuit 33, and the pulse signal VG is output while the H level is inverted to an L level, and vice versa.

FIG. 3 is a circuit diagram showing a detailed configuration of the switching unit S1a shown in FIG. 2. The switching unit S1a includes a switch SW1 made up of; for instance, a MOSFET. The switching unit S1a can also be configured such that a gate terminal of the switch SW1 is connected to an output terminal of the AND circuit 32; that a source terminal of the same is connected to the output capacitor Co and an anode of a parasitic diode; and that a drain terminal of the switching unit is connected to the control circuit 1 and the cathode of the parasitic diode. The parasitic diode of the switch SW1 may also be provided independently of the MOSFET. However, in order to implement operation to be described later, the parasitic diode preferably has a rectifying direction as described above.

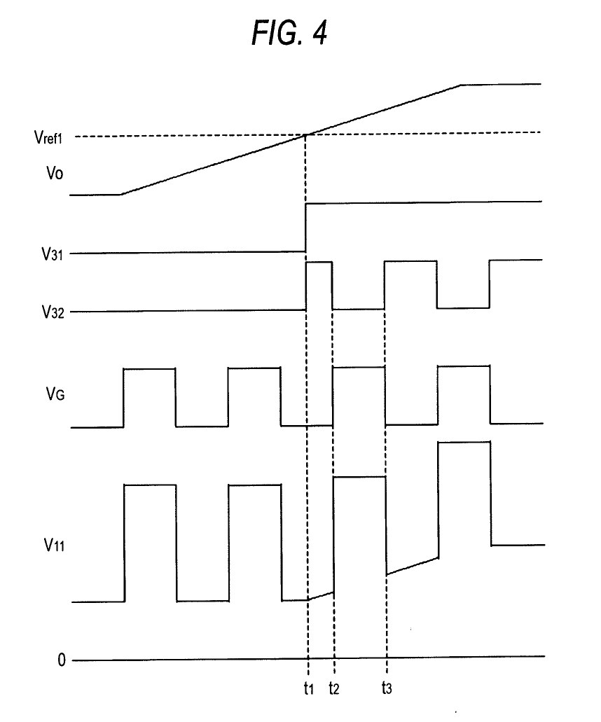

FIG. 4 shows operations of respective sections of the step-down switching regulator shown in FIG. 2. In FIG. 4, the voltage V11 corresponds to a voltage appearing at a point of connection between the switching unit S1a and the control circuit 1 with reference to the GND.

When activating and deactivating operations of the switching element Q1 are started, the DC output voltage Vo gradually increases. Subsequently, when the DC output voltage Vo becomes greater than the first reference voltage Vref1 at time t1, the output V31 from the first comparator 31 is inverted, to thus come to an H level. At this time, since the pulse signal VG remains at an L level (that is, since the output from the NOT circuit remains at an H level), the output V32 of the AND circuit 32 comes to an H level, whereupon the switching unit S1a becomes closed (turned ON). Since the capacitor 11 is recharged with the DC output voltage Vo by way of the switching unit S1a, the voltage V11 becomes substantially equal to the DC output voltage Vo.

When the pulse signal VG comes to an H level (that is, when the output from the NOT circuit 33 comes to an L level) at time t2, the DC input voltage Vin is superposed on the recharging voltage for the capacitor 11 along with activation of the switching element Q1, whereby the voltage V11 becomes higher than the DC output voltage Vo. At this time, according to the present invention, when the pulse signal VG comes to the H level at time t2, the output V32 from the AND circuit 32 comes to an L level, whereupon the switching unit S1a becomes open (turned OFF). Recharging of the capacitor 11 with the DC output voltage Vo is stopped.

When the pulse signal VG comes to an L level at time t3, the output V32 from the AND circuit 32 again comes to the H level, whereupon the switching unit S1a becomes closed (turned ON). Recharging the capacitor 11 with the DC output voltage Vo is resumed.

When the voltage V11 becomes higher than the DC output voltage Vo through such an operation along with activation of the switching element Q1, the switching unit S1a is opened (turned OFF), and hence destruction of the load R1 and the signal generation unit 3a, which would otherwise be caused by the voltage V11, can be prevented. By means of such an operation, emission of electric charges of the capacitor 11 to the output capacitor Co, which would otherwise be caused in conjunction with activation of the switching element Q1, can be prevented.

The step-down switching regulator of the present embodiment yields the following advantages.

(1) When the DC output voltage Vo is higher than the first reference voltage Vref1, the switching unit S1a is switched so as to recharge the capacitor 11 with the DC output voltage Vo, whereby the loss arising in the voltage generation unit 2 can be reduced. Hence, a step-down switching regulator exhibiting high conversion efficiency is obtained.

(2) When the switching element Q1 is activated, to thus superpose the DC input voltage Vin on the charging voltage for the capacitor 11, application of an excess voltage (V11) to the load R1 and the signal generation unit 3a can be prevented by opening (turning OFF) the switching unit S1a, whereby a highly reliable step-down switching regulator is obtained.

(3) It is possible to reduce discharging of the capacitor 11, which would otherwise arise at the time of activation of the switching element Q1, and thus prevent occurrence of incomplete conduction of the switching element Q1. Since the DC output voltage Vo can thereby be controlled well, a highly-reliable step-down switching regulator is obtained.

### Second Embodiment

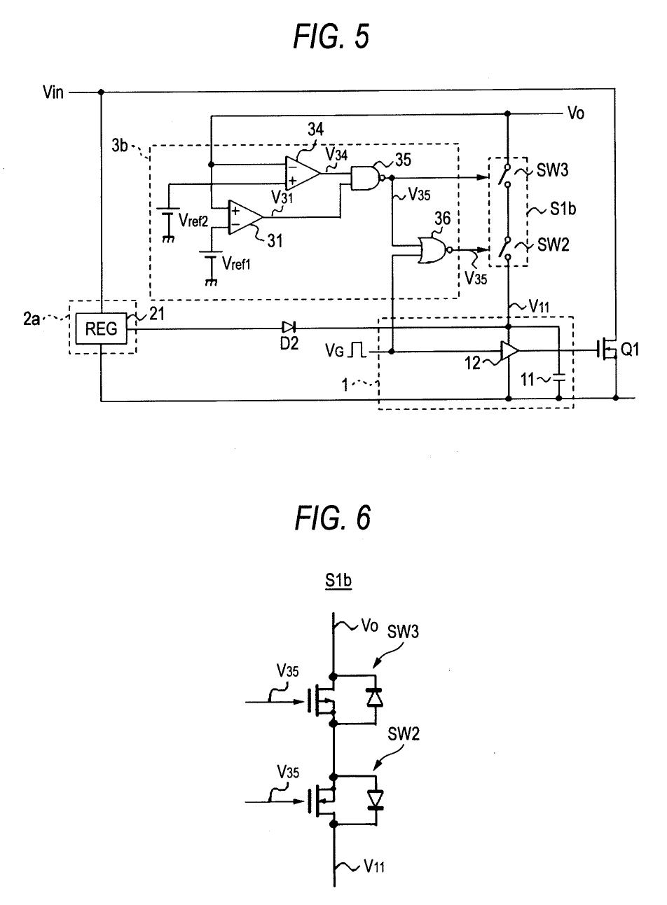

A detailed configuration and operation of a step-down switching regulator of a second embodiment of the present invention will now be described with reference to FIGS. 5 to 7.

FIG. 5 shows the principal section of the step-down switching regulator of the present invention shown in FIG. 1.

The step-down switching regulator of the second embodiment has a modified signal generation unit 3b and a modified switching unit S1b. In other respects, the switching regulator is configured so as to become substantially identical with the step-down switching regulator according to the first embodiment shown in FIG. 2.

In the step-down switching regulator according to the second embodiment, the signal generation unit 3b includes: a first comparator 31; a second comparator 34; a NAND circuit 35; and an NOR circuit 36. When the DC output voltage Vo is higher than the first reference voltage Vref1, the first comparator 31 outputs the H-level comparison signal V31 to one of input terminals of the NAND circuit 35.

The DC output voltage Vo is input to an inverting input terminal of the second comparator 34, and a second reference voltage Vref2 that is higher than the first reference voltage Vref1 is input to a non-inverting input terminal. An H-level or L-level comparison signal V34 is output from an output terminal according to a comparison result. When the DC output voltage Vo is lower than the second reference voltage Vref2, the second comparator 34 outputs an H-level comparison signal to the other input terminal of the NAND circuit 35.

According to a computation result, the NAND circuit 35 outputs an H-level or L-level signal V35 from the output terminal. Only when the output from the first comparator 31 and the output from the second comparator 34 are at an H level, the NAND circuit 35 outputs an L-level signal to one of input terminals of the NOR circuit 36 and a control terminal of a switch SW3. The second reference voltage Vref2 is set in correspondence with a withstand voltage of an element making up the control circuit 1 and a gate-source withstand voltage of the switching element Q1.

The NOR circuit 36 outputs an H-level or L-level signal V36 from an output terminal according to a computing result. Only when an output from the NAND circuit 35 and a pulse signal VG input to the control circuit 1 from the outside are at an L level, the NOR circuit 36 outputs an H-level signal to the control terminal of a switch SW2, thereby closing (turning ON) the switch SW2.

FIG. 6 is a circuit diagram showing a detailed configuration of the switching unit S1b according to the second embodiment shown in FIG. 5. The switching unit S1b is built by series connection of; for instance, the switch SW2 formed from an n-type MOSFET with the switch SW3 formed from a p-type MOSFET. The switch SW2 can be configured such that a gate terminal is connected to an output terminal of the NOR circuit 36; that a source terminal is connected to a source terminal of the switch SW3; and that a drain terminal is connected to the control circuit 1. An anode terminal of a parasitic diode of the switch SW2 is connected the source terminal, and a cathode terminal of the same is connected to the drain terminal. Further, the switch SW3 can also be configured such that a gate terminal is connected to an output terminal of the NAND circuit 35 and that a drain terminal is connected to an output capacitor Co. An anode terminal of a parasitic diode of the switch SW3 is connected to the source terminal, and a cathode terminal of the same is connected to the drain terminal. That is, the parasitic diode of the switch SW2 and the parasitic diode of the SW3 have different rectifying directions. Incidentally, diodes can also be provided independently of the MOSFETs without use of the parasitic diodes of the switches SW2 and SW3. However, in order to accomplish operation to be described later, it is preferable for the switching unit to have different rectifying directions as described above.

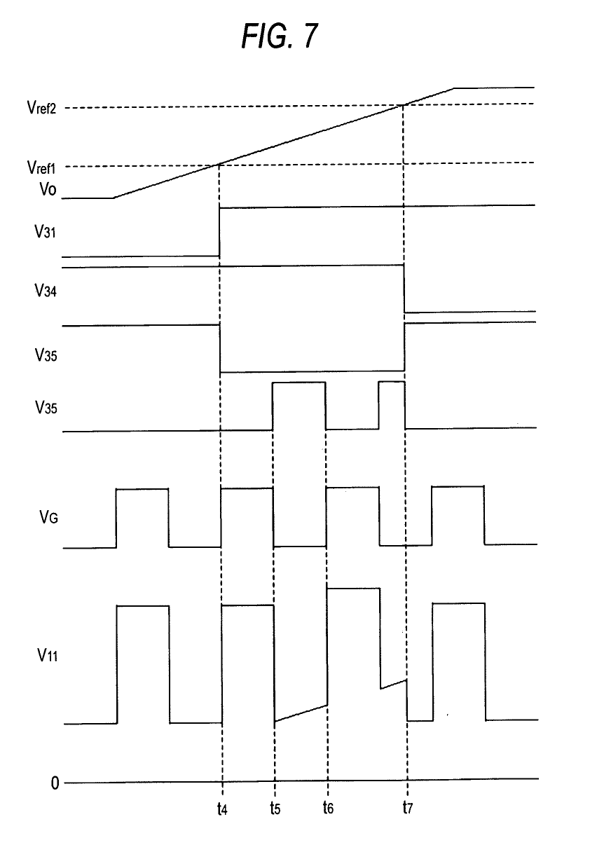

FIG. 7 shows operations of respective sections of the step-down switching regulator according to the second embodiment shown in FIG. 5. In FIG. 7, the voltage V11 is a voltage appearing at a point of connection of the switching unit S1b with the control circuit 1 with reference to the GND.

When the DC output voltage Vo becomes greater than the first reference voltage Vref1 at time t4 after the switching element Q1 has started activating and deactivating operations, the output V31 from the first comparator 31 is inverted, to thus come to an H level. Since the DC output voltage Vo is lower than the second reference voltage, the output V34 from the second comparator 34 comes to an H level. Consequently, the output V35 from the NAND circuit 35 comes to an L level. At this time, when the pulse signal VG comes to an H level, the DC input voltage Vin is superposed on the charging voltage of the capacitor 11 in conjunction with activation of the switching element Q1, so that the voltage V11 becomes higher than the DC output voltage Vo. At this time, according to the present invention, when the pulse signal VG comes to an H level, the output V36 of the NOR circuit 36 comes to an L level, whereupon the switching unit S1b becomes open (turned OFF). More specifically, when the switching unit S1b is configured as shown in FIG. 6, the switch SW3 becomes closed (turned ON), whereupon the switch SW2 becomes open (turned OFF).

When the pulse signal VG comes to an L level at time t5, the output V36 from the NOR circuit 36 comes to an H level, whereupon the switching unit S1b becomes closed (turned ON). More specifically, the switches SW3 and SW2 become closed (turned ON). Since the capacitor 11 is recharged with the DC output voltage Vo by way of the switching unit S1b, the voltage V11 becomes substantially equal to the DC output voltage Vo.

When the pulse signal VG comes to an H level at time t6, a DC input voltage Vin is superposed on the charging voltage of the capacitor 11 in conjunction with activation of the switching element Q1, whereby the voltage V11 becomes higher than the DC output voltage Vo. At this time, according to the present invention, when the pulse signal VG comes to an H level at time t6, the output V36 from the NOR circuit 36 comes to an L level, whereupon the switching unit S1b becomes open (turned OFF). More specifically, the switch SW2 becomes open (turned OFF). Recharging the capacitor 11 with the DC output voltage Vo is stopped.

When the DC output voltage Vo becomes higher than the second reference voltage Vref2 at time t7, the output V34 from the second comparator 34 becomes inverted, to thus come to an L level. Accordingly, the output V35 from the NAND circuit 35 comes to an H level, and the output V36 from the NOR circuit 36 comes to an L level, whereupon the switching unit S1b becomes open (turned OFF). More specifically, the switches SW2 and SW3 are held in an open (turned OFF) state without depending on the pulse signal VG.

When the voltage V11 becomes higher than the DC output voltage Vo in conjunction with activation of the switching element Q1, the switching unit S1b is opened (turned OFF) through such an operation, destruction of the load R1 and the signal generation unit 3b, which would otherwise be caused by the voltage V11, can be prevented. Moreover, the switching unit S1b is opened (turned OFF) when the DC output voltage Vo becomes higher than the withstand voltage of the control circuit 1, destruction of the control circuit 1 and a path between the gate and the source of the switching element Q1, which would otherwise be caused by the DC output voltage Vo, can be prevented.

In addition to yielding the advantages analogous to those yielded by the step-down switching regulator of the first embodiment, the step-down switching regulator of the present embodiment yields the following advantages.

When the DC output voltage Vo is higher than the withstand voltage of the control circuit 1, the capacitor 11 is not directly recharged with the DC output voltage Vo. Therefore, when the voltage required by the load R1 is high, destruction of the control circuit 1 can be prevented. Accordingly, a step-down switching regulator having higher reliability is obtained. Further, since there is no necessity for causing the control circuit 1 to withstand a greater voltage, the control circuit 1 can be miniaturized, so that the step-down switching regulator can be configured comparatively inexpensively.

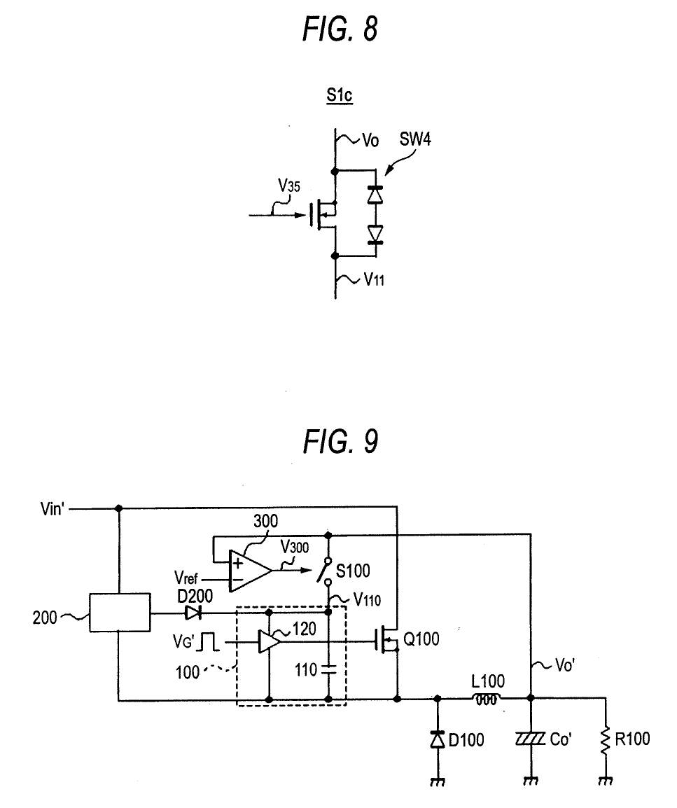

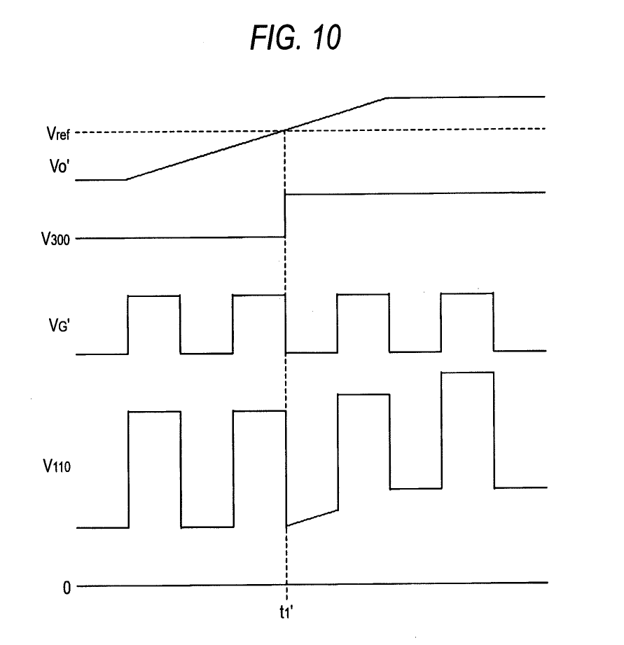

FIG. 8 is a circuit diagram showing a detailed configuration of a switching unit S1c of a modification of the second embodiment. The switching unit S1c includes a switch SW4 built from an n-type MOSFET having a plurality of parasitic diodes whose rectifying directions differ from each other. The switch SW4 can be configured such that a gate terminal is connected to an output terminal of the NOR circuit 36 shown in FIG. 5; that a source terminal is connected to the output capacitor Co; and that a drain terminal is connected to the control circuit 1. Respective anode terminals of the plurality of parasitic diodes of the switch SW4 are connected together, and respective cathode terminals of the parasitic diodes are connected to the drain terminal and the source terminal of the switch SW4.

By means of such a configuration, the switching unit S1c is made up of one MOSFET. Hence, the number of components can be curtailed, so that a compact, inexpensive step-down switching regulator is obtained.

It is desirable that the step-down switching regulator of the second embodiment is configured such that, when the DC output voltage Vo becomes higher than the second reference voltage, the switching unit S1b becomes open (turned OFF) and that the capacitor 11 is recharged with the DC output voltage Vo by way of the voltage generation unit 2.

By means of such a configuration, when the DC output voltage Vo becomes higher than the withstand voltage of the control circuit 1, the capacitor 11 can be recharged with the DC output voltage Vo. When compared with the case where the capacitor 11 is recharged with the DC input voltage Vin, the loss arising in the voltage generation unit 2 can be lessened. Accordingly, there is provided a step-down switching regulator exhibiting higher conversion efficiency.

The embodiments of the step-down chopper circuit have been described as example embodiments of the present invention thus far. However, the present invention is not limited to the specific embodiments and can be applied to a step-down switching regulator; for instance, a synchronous rectifying circuit, or the like. Further, the present invention is susceptible to various modifications, alterations, and combinations of the embodiments within the scope of the gist of the present invention defined in claims. For example, the configuration of the signal generation unit 3 is not limited to the above configuration (3a, 3b), and a logic circuit can be changed, as required. Moreover, the switching element Q1 can be replaced with; for instance, a lower-voltage side switching element of the synchronous rectifying circuit. The switching unit S1 can also be formed from an element other than the MOSFET and also be configured such that the voltage generation unit 2 is activated or deactivated in synchronism with opening or closing of the switching unit S1. Further, independent voltage generation unit can also be provided between the output capacitor Co and the control circuit 1. Moreover, the reflux prevention diode D2 can also be replaced with a switch, such as a MOSFET.

What is claimed is:

1. A switching regulator for stepping down a DC input voltage to a DC output voltage, the switching regulator comprising:
a switching element;
a control circuit that controls activation or deactivation of the switching element;
a voltage generation unit that steps down the DC input voltage and supplies the stepped down DC input voltage to the control circuit; and
a switching unit that is configured to:
supply the DC output voltage to the control unit when the DC output voltage is equal to or higher than a first reference voltage; and
stop supply of the DC output voltage when the switching element is in an active state.

2. The switching regulator according to claim 1,
wherein when the DC output voltage is equal to or higher than a second reference voltage value that is greater than the first reference voltage value, the switching unit stops supply of the DC output voltage.

3. The switching regulator according to claim 1,
wherein when the DC output voltage is equal to or higher than a second reference voltage value that is greater than the first reference voltage value, the switching regulator steps down the DC output voltage and supplies the stepped down DC output voltage to the control unit.

4. The switching regulator according to claim 3,
wherein, when the DC output voltage is equal to or higher than the second reference voltage value, the voltage generation unit steps down the DC output voltage and supplies the stepped down DC output voltage to the control unit.

5. The switching regulator according to claim 1,
wherein the voltage generation unit steps down the DC input voltage and supplies control power for driving the control circuit and bias power for driving the switching element to the control circuit, and
wherein the switching unit supplies the DC output voltage as the control power and the bias power to the control circuit.

6. The switching regulator according to claim 1,
wherein the switching unit comprises at least one diode, and
wherein an anode of the at least one diode is connected to the DC output voltage.

7. A controlling method of a switching regulator for stepping down a DC input voltage to a DC output voltage by activating and deactivating a switching element, the switching regulator comprising: the switching element; a control circuit for controlling activation or deactivation of the switching element; a voltage generation unit that steps down the DC input voltage and supplies the stepped down DC input voltage to the control circuit, the controlling method comprising:
supplying the DC output voltage to the control circuit when the DC output voltage is equal to or greater than the first reference voltage value; and
stopping supply of the DC output voltage when the switching element is in an activated state.
